(19) United States
(12) Patent Application Publication
(10) Pub. No.: US 2008/0152111 A1
(43) Pub. Date: Jun. 26, 2008

(54) HANDLING OF INCOMING CALLS

(75) Inventors: Von A. Mock, Boynton Beach, FL (US); Charles P. Schultz, North Miami Beach, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/616,168

(22) Filed: Dec. 26, 2006

(51) Int. Cl. H04M 3/42

(52) U.S. Cl. 379/142.17; 379/142.01

(57) ABSTRACT

A method (300) that can include receiving a call identifier (130) for an incoming call and associating the incoming call with at least one category (140, 145, 150) selected from a group consisting of at least three categories. An indicator (160) that correlates to the category with which the incoming call is associated can be presented to a user (120). Presenting the indicator can include presenting a particular color to the user and/or presenting a vibration, sound or image to the user. The method further can include automatically responding to the incoming call with a particular greeting only if the call identifier is blank or indicates an unknown caller (125). In another arrangement, the method can include automatically responding to the incoming call with a particular greeting only if the caller is unknown and the call identifier indicates that the caller is a particular gender or is exhibiting a particular emotion.

### BACKGROUND OF THE INVENTION

1. Field of the Invention

The present invention generally relates to telecommunications and, more particularly, to handling of incoming calls.

2. Background of the Invention

Annually there are well over a million people within the United States who are stalked. Although a significant number of males also are stalked, the victims of stalkers are predominantly female. Indeed, statistics show that one in twenty women will be stalked in their lifetime. Stalkers typically are motivated by a desire to control their victims' actions and feelings, and often attempt to do so by contacting and harassing their victims with telephone calls. Alarmingly, a large percentage of these stalkings end in physical violence.

According to the National Institute of Justice, in over twenty percent of stalking cases the victims do not know their stalkers. Thus, it can be very difficult for a victim to know who to avoid, and who not to avoid, as she goes about her daily life. When a victim knows she is being stalked but does not know who the stalker is, she may hesitate answering incoming telephone calls, even though some of these calls may be from trusted individuals with whom she would wish to speak.

### SUMMARY OF THE INVENTION

The present invention relates to a method for processing an incoming call. The method can include receiving a call identifier for the incoming call and associating the incoming call with at least one category selected from a group consisting of at least three categories. A non-textual indicator that correlates to the category with which the incoming call is associated can be presented to a user. Presenting the non-textual indicator can include presenting a particular color, graphic, odor, vibration, sound and/or image to the user.

Associating the incoming call with the category can include selecting the category based, at least in part, on a social status of the caller or an emotion detected from the caller. Further, receiving the call identifier can include receiving an age of a caller. In this arrangement, associating the incoming call with the category can include selecting the category based, at least in part, on the age of the caller. Associating the incoming call with the category also can include selecting the category based, at least in part, on the age of the user.

The method further can include automatically responding to the incoming call with a particular greeting only if the call identifier is blank or indicates an unknown, unidentified or undesirable caller. In another arrangement, the method can include automatically responding to the incoming call with a particular greeting only if the caller is unknown and the call identifier indicates that the caller is a particular gender or is exhibiting a particular emotion.

The present invention also relates to a method that can include receiving a call identifier for the incoming call and automatically responding to the incoming call with a masculine greeting only if the call identifier is blank or indicates a caller is unknown, unidentified or undesirable. Automatically responding to the incoming call with a masculine response can include responding to the incoming call with a greeting in a masculine voice and/or responding to the incoming call with a masculine image. In another arrangement, automatically responding to the incoming call with a masculine response can include responding to the incoming call with a voice and/or an image that approximately matches the caller's age. The method further can include automatically responding to the incoming call with a second greeting presented with a user's voice and/or image only if the call identifier indicates that the caller is known.

The present invention also relates to a communication device. The communication device can include a communications adapter that receives a call identifier for an incoming call, a controller that associates the incoming call with at least one category selected from a group consisting of at least three categories, and a user interface that presents to a user a non-textual indicator that correlates to the category with which the incoming call is associated. The user interface can present the non-textual indicator to the user as a particular color, vibration, sound and/or image.

The controller can select the category based, at least in part, on a social status of the caller. Further, the call indicator can include an age of a caller and the controller can select the category based, at least in part, on the age of the caller. In one arrangement, the controller can respond to the incoming call with a particular greeting only if the call identifier is blank or indicates an unknown, unidentified or undesirable caller. In another arrangement, the controller can respond to the incoming call with a particular greeting only if the caller is unknown and the call identifier indicates that the caller is a particular gender and/or is exhibiting a particular emotion.

The present invention also can be embedded in a program storage device readable by a machine, tangibly embodying a program of instructions executable by the machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a system that is useful for understanding the present invention;

FIG. 2 depicts a block diagram of a communications device that is useful for understanding the present invention; and

FIG. 3 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method for processing an incoming call. In particular, the call can be assigned to at least one category selected from among three or more call indicator categories. Such categories can include, for example, one or more categories for calls received from known contacts, one or more categories for calls received from callers who are not contained in a user's contact list, and a category for calls received from unidentified callers. Moreover, the calls may be categorized based on whether the calling party likely is male or female.

An indicator associated with the category to which the call is assigned can be presented when the call is received so as to immediately alert the user how the call is categorized. Further, if the call is received from an unidentified caller or an unknown caller who likely is male or an angry caller, the call can be immediately forwarded to voice mail, and the greeting that is played can be presented in a strong masculine voice. Accordingly, would-be stalkers may be dissuaded from attempting further contact with the user.

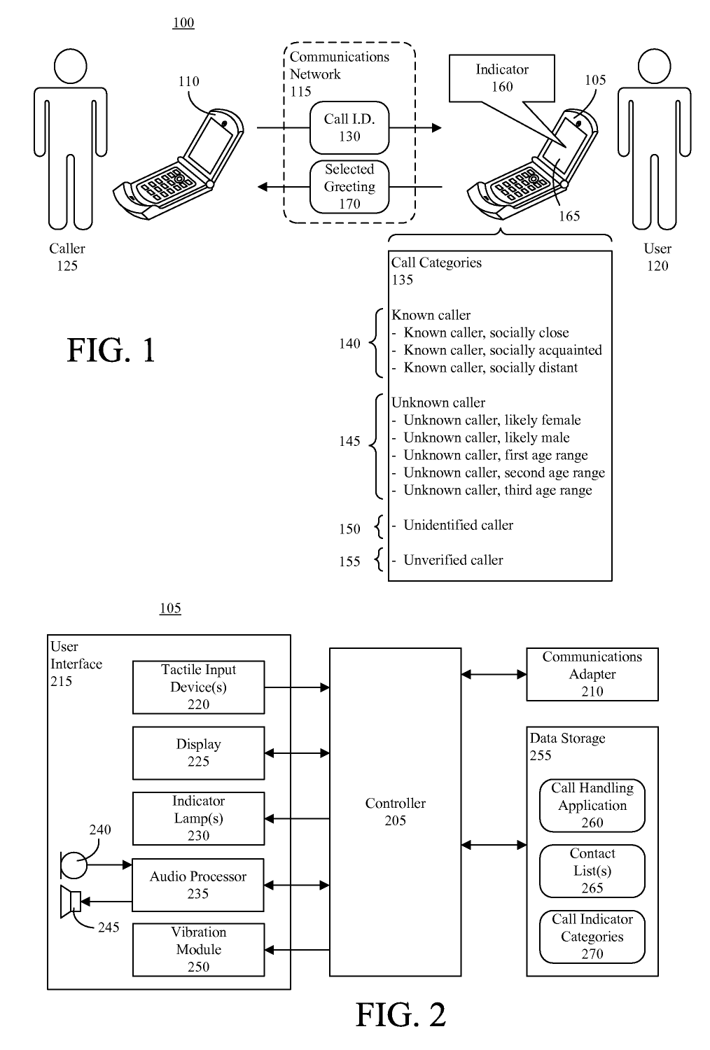

FIG. 1 depicts a system 100 that is useful for understanding the present invention. The system 100 can include a first communication device 105 and a second communication device 110. The communication devices 105, 110 can be telephones, computers, mobile stations (e.g. mobile telephones, mobile radios, mobile computers, personal digital assistants, and the like), handheld gaming or entertainment devices, or any other communication devices that can exchange audio and/or video signals.

Further, the first and second communication devices 105, 110 can communicate in any suitable manner. For instance, the communication devices 105, 110 can communicate via a communications network 115, which may comprise the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network 115 can include wired and/or wireless communication links.

The communication device 105 can be associated with a user 120 and the second communication device 110 can be associated with a caller 125 who is placing a call to the communication device 105. When the call is placed, a call identifier 130 can be communicated to the communication device 105. The call identifier 130 can include information about the caller 125, for example a name, gender, age, emotion and/or health status of the caller 125, or an image of the caller 125. The call identifier 130 also can include a telephone number associated with the caller 125 or the communication device 110, a location from where the call is being placed (e.g. street address, city, zip code, county, state, province and/or country), and/or any other information associated with the caller 125 and/or the communication device 110. The call identifier 130 can include information generated by infrastructure of the communications network 115, for instance by a server having access to the caller's identification information. The call identifier 130 also can include other information entered by the caller 125. Such information can be entered as a user profile stored on the communication device 110 or entered as part of the call initiation process.

In response to receiving the call identifier 130, the communication device 105 can categorize the incoming call into a category selected from at least three call categories 135. For instance, if the call identifier 130 indicates that the caller 125 is known to the user 120, for example the caller's name is contained in the user's contact list on the communication device 105, the incoming call can be associated with a known caller category 140. If the call identifier 130 indicates that the caller 125 is not known to the user 120, for example the caller's name is not contained in the user's contact list, the incoming call can be associated with an unknown caller category 145. Further, if the call identifier 130 is blank or indicates an unidentified caller, the incoming call can be associated with an unidentified caller category 150. Moreover, if a caller identifier 130 is received, but the caller identifier is missing a digital certificate to verify the caller identifier, the incoming call can be associated with an unverified caller category 155.

In one arrangement, the call categories 135 can include a plurality of sub-categories. For instance, the category 140 for known callers can include categories for known callers who are socially close to the user 120, known callers who are socially acquainted with the user 120, and known callers who are socially distant from the user 120. Socially close callers can be those callers with whom the user 120 has frequent contact. Socially acquainted callers can be those callers with whom the user 120 has infrequent contact. Socially distant callers can be those callers with whom the user rarely has contact, but who, nonetheless, are in the user's contact list.

Similarly, the category 145 for unknown callers also can include a plurality of sub-categories. Examples of such categories can include categories for unknown callers who likely are female, unknown callers who likely are male, unknown callers in a first age range, unknown callers in a second age range, and unknown callers in a third age range. Of course, categories can be included for any number of age ranges. The age ranges can be based on absolute age of the caller 125, or a difference in age between the caller 125 and the user 120 and/or whether the caller 125 is older or younger than the user 120.

In yet another arrangement, categories for known or unknown callers can include categories representing the health status of the caller 125. Still, the call categories 135 can include any other categories that can be associated with the caller 125 and the invention is not limited in this regard. Moreover, the incoming call can be categorized into more than one category. For instance, if the call identifier 130 indicates a socially close known caller who is in poor health, the incoming call can be associated with both such categories. It should be noted that any number of categories 140, 145, 150 can be included in the call categories 135 and the invention is not limited in this regard.

Based on the categories 135 with which an incoming call is associated, an indicator 160 can be presented by the communication device 105. In one arrangement, the indicator 160 can be a non-textual indicator. For instance, the indicator can comprise a particular color, odor, graphic, vibration, sound and/or image presented by a user interface of the communication device 105. For example, the color of backlighting used to illuminate the communication device's display 165 can be selected based upon the categories with which the incoming call is associated. Indicator lamps also can be used to indicate such associations. Further, a graphic can be presented on the display 165

Further, a myriad of colors and shades can be presented as the indicator 160. For instance, a deep red can represent a socially close caller 125 who is close in age to the user 120, whereas a lighter shade of red may represent a socially close caller 125 who is a little older or younger than the user 120. Along those lines, the color orange may represent a socially close caller 125 who is ten years older or younger than the user. Similarly, the color blue can represent a socially distant caller 125 who is much different in age than the user 120, whereas green may represent a socially distant caller 125 who is a few years older or younger than the user 120.

Vibrations, ring tones, and other indicators can be used as the indicator 160 in addition to, or in lieu of, color. Moreover, effects, such as flashing or pulsing can be applied to the indicator 160. For instance, if the caller 125 is not identified, the indicator 160 can be presented as a flashing red color or a pulsed vibration. Accordingly, the user 120 can be immediately aware that the caller 125 is unknown.

If call identifier 130 indicates that the caller 125 is known to the user 120, an illumination of color, a vibration and/or a ring tone can be presented to the user 120 to alert the user 120 that an incoming call is being received. If, however, the call identifier 130 indicates that the caller 125 is not known to the user 120 or the call identifier 130 is blank, the incoming call can be automatically connected to an automated response system. The manner in which the automated response system processes the incoming call can be determined by information contained in the call identifier 130, if any. Further, if the call identifier 130 cannot be verified, the user can be prompted to accept the call, to respond to the call with a regular voice mail response, or to respond to the call with a specialized response, for instance with a male voice. In addition, the user's selection can be stored and used again to respond to future calls with the same unverified user identifier 130.

In one aspect of the invention, if the gender of the caller 125 is not indicated in the call identifier 130, an attempt to automatically identify the gender can be made by the communication device 105 and/or infrastructure of the communications network 115. For example, if the call identifier 130 contains a given name that is traditionally a male name, a determination can be made that the gender of the caller 125 is male. Similarly, if the call identifier 130 contains a given name that is traditionally a female name, a determination can be made that the gender of the caller 125 is female.

In some languages female names may end with a particular letter while male names end with another letter. Thus, if a given name is not otherwise identified as male or female, the location of the caller 125 and the last letter of the caller's given name can be processed to indicate the caller's gender. For instance, in Spanish speaking regions, given names ending in “a” can indicate that the caller is female while given names ending in “o” or “e” can indicate that the caller is male.

In an arrangement in which the call identifier 130 includes an image, image processing can be implemented to determine whether the image is likely associated with a male or female. For instance, if the image is a picture of the caller 125, features of the caller 125 can be identified to determine the caller's gender. If some other type of image is included in the call identifier 130, the type of image can be identified and a determination of the caller's gender can be based on the statistical possibilities of such an image being associated with a male or female.

In another arrangement, the caller's gender can be determined by customer information, for instance account or billing records, stored at an infrastructure location (e.g. a server) within the communications network 115. For example, if the caller's customer information is associated with the term “Mr.,” the caller can be determined to be male. Similarly, if the caller's customer information is associated with the term “Mrs.,”, “Ms.,” or “Miss,” the caller can be determined to be female.

An emotion exhibited by the caller 125 also can be estimated. For example, the caller can be prompted to utter a spoken utterance as part of the call process, and the spoken utterance can be processed to detect the caller's emotion. In another arrangement, breathing patterns of the caller 125 detected and processed to detect the caller's emotion.

If the user 120 fits a profile indicating that the user 120 may be stalked by a stalker or otherwise receive unwelcome advances, or that the caller is angry, incoming calls from an unidentified caller 125 can be immediately sent to voice mail and a selected greeting 170 can be communicated to the communication device 110 for presentation to the caller 125. For example, if the user 120 is a minor or a female, a greeting in a strong masculine voice and/or a masculine image can be communicated to the communication device 110 for presentation to the caller 125. Similarly, if an incoming call is received from an unknown caller 125 who appears to be male, or an unknown caller 125 is much older than the user 120, a greeting 170 in a strong masculine voice and/or a masculine image can be communicated to the communication device 110 for presentation to the caller 125. Further, if the caller 125 appears to be angry, an angry response can be communicated to the caller.

In another arrangement, if the incoming call is from an unknown caller 125 who appears to be a particular gender, a particular age, and/or is exhibiting a particular emotion (e.g. anger) the greeting can be presented to the caller 125 with a voice that approximately matches the caller's gender, age and/or emotion. An image also can be presented that approximately matches the caller's gender, age and/or emotion. If, however, the caller 125 is a known caller, the greeting 170 can be presented to the caller 125 with the user's voice and/or with the user's image. Still, any number of greetings can be presented, and such greetings can be based on any of a myriad of conditions and information contained in the call identifier 130, and the invention is not limited to these examples. Moreover, such conditions can be user definable or user selectable. For instance the user can select or define conditions via a user interface on the communication device 105.

FIG. 2 depicts an example of the communication device 105 that is useful for understanding the present invention. The communication device 105 can include a controller 205. The controller 205 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The communication device 105 also can include a communications adapter 210 with which the communication device 105 uses to communicate with other communication devices via the communications network during call sessions. For example, the communications adapter 210 can receive incoming calls and can receive call identifiers associated with the incoming calls.

The communications adapter 210 can be any communications adapter compatible with the communications network to which the communication device 105 is linked. For example, the communications adapter 210 can include a transceiver that communicates signals in accordance with IEEE 802 wireless communications, for example, 802.11 and 802.16 (WiMax), WPA, WPA2, GSM, TDMA, CDMA, WCDMA, OFDM, Bluetooth, ZigBee, direct wireless communication, TCP/IP, or in accordance with any other communications protocol supported by the communications network. In that regard, the communications adapter 210 can communicate via a wired and/or wireless communications link.

The communication device 105 also can include a user interface 215 comprising one or more tactile input devices 220 and a display 225. The tactile input devices 220 can comprise one or more buttons, keys, soft keys, sensors, or any other devices suitable for receiving a tactile user input. The display 225 can be a liquid crystal display (LCD), a liquid crystal on silicon (LCOS) display, a cathode ray tube (CRT), a plasma display, or any other suitable display. In one arrangement the display 225 can be a color display and/or can include backlighting having variable color so as to present the aforementioned indicator to the user of the communication device 105. In one arrangement, the display 225 can comprise a touch screen that can receive tactile and/or stylus inputs and communicate such inputs to the processor 205.

One or more indicator lamps 230 also can be provided in the user interface 215 to present the indicator. In an arrangement in which a single indicator lamp 230 is provided, the color of the indicator lamp may be dynamically variable. In an arrangement in which a plurality of single color indicator lamps 230 are provided, each of the indicator lamps 230 can illuminate in a different color.

The user interface 215 further can include an audio processor 235 connected to an input audio transducer 240 (e.g. microphone) and an output audio transducer 245 (e.g. loudspeaker). The audio processor 235 can be integrated with the controller 205 or provided as a separate component that is communicatively linked to the controller 205. The audio processor 235 can comprise a CPU, a DSP, an ASIC, a PLD, a plurality of discrete components that cooperate to process audio data, and/or any other suitable audio processing device.

The audio processor 235 can receive input audio signals from the input audio transducer 240 and communicate such signals to the controller 205. The audio processor 235 also can receive output audio signals from the controller 205 and communicate such signals to the output audio transducer 245. In an arrangement in which the indicators presented to the user are audibly presented, the audio processor 235 can communicate the indicators to the output audio transducer 245 at the behest of the controller 205.

A vibration module 250 also can be provided with the user interface 215. In an arrangement in which the indicator presented to the user in response to an incoming call comprises a vibration, the vibration module 250 can receive indicator signals from the controller 205 in response to such a call. As noted, a variety of vibration patterns can be provided to represent one or more different call categories.

The communication device 105 further can include data storage 255. The data storage 255 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 255 can be integrated into the controller 205, though this need not be the case.

A call handling application 260, one or more contact lists 265, and call indicator categories 270 can be contained on the data storage 255. The controller 205 can execute the call handling application 260 to implement the processes and methods described herein. For example, at runtime, in response to a call identifier being received for an incoming call, the call handling application 260 can associate the incoming call with one or more call categories. As noted, the call categories that are associated with the incoming call can be based, at least in part, on whether the identified caller is contained in the contact list 265, a social status of the caller, an age of the caller, a gender of the caller, a health status of the caller, an emotion of the caller, and/or based on other relevant information.

The call handling application 260 also can respond to the incoming call with a particular greeting if the call identifier is blank or indicates an unidentified caller, or if the caller is unknown and the call identifier indicates a particular gender. The call handling application 260 also can present the indicator to the user of the communication device 105, via the user interface 215, to indicate which category (or categories) is associated with the incoming call. As noted, the user interface can present the indicator as a particular color, as a sound, as an image, as an odor and/or as a vibration.

Further, the call handling application 260 can receive a user via the user interface 215 to indicate whether a particular caller is undesirable and the caller does not wish to receive calls from the caller, for instance if the caller is hostile or is a nuisance. The call handling application 260 can indicate that the caller is undesirable in the contact list 265, and such indication can be considered during incoming call processing. For example, calls received from the caller can be sent straight to voice mail with a particular type of greeting.

In one aspect of the invention, the functionality of the call handling application 260 can be allocated across multiple systems. For instance, certain functions, such as presenting indicators, can be performed on the communication device while other functions, such as selecting and generating the greetings, can be performed by infrastructure of the communications network. Examples of such infrastructure can include, but are not limited to, a mobile switching center (MSC), a base station controller (BSC), a server, and/or other network infrastructure. User selections and settings can be communicated to such infrastructure at the time an incoming call is received, or prior to an incoming call being received, for instance during account setup or maintenance operations.

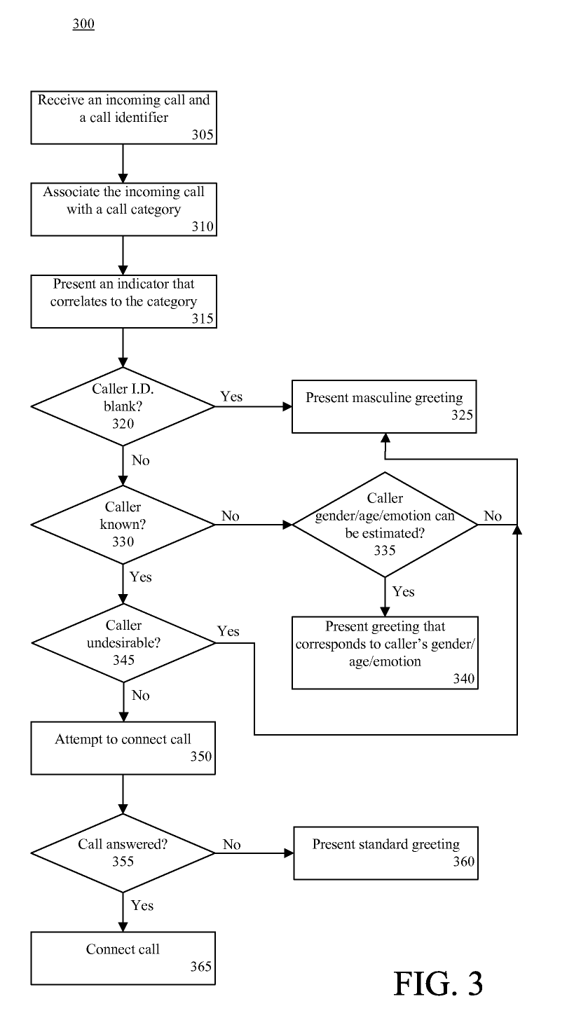

FIG. 3 is a flowchart that presents a method 300 that is useful for understanding the present invention. At step 305 an incoming call and an associated call identifier, if available, can be received. At step 310, based on the information contained in the call identifier, or lack thereof, the incoming call can be associated with a call category. At step 315 an indicator associated with the call category can be presented to a user. As noted, the indictor can be presented as a color, a sound, image and/or a vibration.

Referring to decision box 320, if the call identifier is blank or was not received, at step 325 a masculine greeting can be automatically presented to the caller. For example, a masculine voice and/or a masculine image can be presented to the caller. If the call identifier was received and is not blank, at decision box 330 a determination can be made whether the caller is known. If the caller is not known, at decision box 335 a determination can be made whether the gender, age and/or emotion of the caller can be estimated. If not, then the process can proceed to step 325 and the masculine greeting can be presented to the caller. If, however, the caller gender, age and/or emotion can be estimated, the process can proceed to step 340 and a greeting that corresponds to the caller's gender, age and/or emotion can be presented to the caller.

Referring again to decision box 330, if the caller is known, at step 345 a determination can be made whether the caller is undesirable. If so, the process can proceed to 325 and the masculine greeting or other desired greeting can be presented to the caller. If the caller is not undesirable, at step 350 an attempt can be made to connect the call to the communication device. Continuing to decision box 355, if the call is not answered, at step 360 a standard greeting can be presented to the caller. If the call is answered, at step 365 the call can be connected.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for processing an incoming call, comprising:
receiving a call identifier for the incoming call;
associating the incoming call with at least one category selected from a group consisting of at least three categories; and
presenting to a user a non-textual indicator that correlates to the category with which the incoming call is associated.

2. The method of claim 1, wherein associating the incoming call with the category comprises selecting the category based, at least in part, on a social status of the caller.

3. The method of claim 1, wherein:
receiving the call identifier comprises receiving an age of a caller; and
associating the incoming call with the category comprises selecting the category based, at least in part, on the age of the caller.

4. The method of claim 3, wherein associating the incoming call with the category further comprises selecting the category based, at least in part, on the age of the user.

5. The method of claim 1, further comprising:
automatically responding to the incoming call with a particular greeting only if the call identifier is blank or indicates an unknown, unidentified or undesirable caller.

6. The method of claim 1, further comprising:
automatically responding to the incoming call with a particular greeting only if the caller is unknown and the call identifier indicates that the caller is a particular gender or is exhibiting a particular emotion.

7. The method of claim 1, wherein presenting the non-textual indicator comprises presenting a particular color to the user.

8. The method of claim 1, wherein presenting the non-textual indicator comprises presenting a vibration, graphic, odor, sound or image to the user.

9. A method for processing an incoming call, comprising:
receiving a call identifier for the incoming call; and
automatically responding to the incoming call with a masculine greeting only if the call identifier is blank or indicates a caller is unknown, unidentified or undesirable.

10. The method of claim 9, wherein automatically responding to the incoming call with a masculine response comprises responding to the incoming call with a greeting in a masculine voice.

11. The method of claim 9, wherein automatically responding to the incoming call with a masculine response comprises responding to the incoming call with a masculine image.

12. The method of claim 9, wherein automatically responding to the incoming call with a masculine response comprises responding to the incoming call with a voice that approximately matches the caller's age.

13. The method of claim 9, wherein automatically responding to the incoming call with a masculine response comprises responding to the incoming call with an image that approximately matches the caller's age.

14. The method of claim 9, further comprising automatically responding to the incoming call with a second greeting presented with a user's voice or image only if the call identifier indicates that the caller is known.

15. A communication device, comprising:
a communications adapter that receives a call identifier for an incoming call;
a controller that associates the incoming call with at least one category selected from a group consisting of at least three categories; and
a user interface that presents to a user a non-textual indicator that correlates to the category with which the incoming call is associated.

16. The communication device of 15, wherein the controller selects the category based, at least in part, on a social status of the caller.

17. The communication device of 15, wherein:
the call indicator comprises an age of a caller; and
the controller selects the category based, at least in part, on the age of the caller.

18. The communication device of 15, wherein the controller responds to the incoming call with a particular greeting only if the call identifier is blank or indicates an unknown, unidentified or undesirable caller.

19. The communication device of 15, wherein the controller responds to the incoming call with a particular greeting only if the caller is unknown and the call identifier indicates that the caller is a particular gender or is exhibiting a particular emotion.

20. The communication device of 15, wherein the user interface presents the non-textual indicator to the user as a particular color or as a vibration, graphic, odor, sound or image.
